(19) United States
(12) Patent Application Publication
(10) Pub. No.: US 2026/0112854 A1
(43) Pub. Date: Apr. 23, 2026

(54) SLOT-IN CONNECTOR

(71) Applicant: HOSIDEN CORPORATION, Osaka (JP)

(72) Inventors: Hiroki MARUYAMA, Gunma (JP); Tatsuya MORISHITA, Gunma (JP); Yutaka TAKAHASHI, Gunma (JP)

(73) Assignee: HOSIDEN CORPORATION, Osaka (JP)

(21) Appl. No.: 19/358,736

(22) Filed: Oct. 15, 2025

(30) Foreign Application Priority Data
Oct. 21, 2024 (JP) 2024-184744

(51) Int. Cl. H01R 31/06; H01R 13/02; H01R 13/506; H01R 13/512; H01R 13/66; H01R 13/717

(52) U.S. Cl. CPC H01R 31/065; H01R 13/025; H01R 13/506; H01R 13/512; H01R 13/6658; H01R 13/7172; H01R 13/7175

(57) ABSTRACT

A slot-in connector including a connector unit and an adapter includes a connector, an illuminating member, a light guide, a board, a case, and a cable. The connector is mounted on the board and includes an insertion hole that is open in a first direction. The illuminating member illuminates the periphery of the insertion hole. The case includes a main body part and a first latch part. The main body part includes a first opening part that exposes the illuminating member to the outside of the case. The cable has one end part electrically connected to the board and another end part extracted to the outside of the case. The adapter includes a second opening part that exposes the illuminating member to the outside of the adapter, a first cut-out part that is open in the second direction, and a first engagement part engaged with a first protruding part.

### TECHNICAL FIELD

The present disclosure relates to a slot-in connector.

BACKGROUND ART

In Japanese Patent Application Laid Open No. H9-330775 (hereinafter referred to as Patent Literature 1), a cable repeater with a fixture that connects internal equipment and external equipment of an apparatus to each other is described.

The cable repeater in Patent Literature 1 includes an extension cable that connects the internal equipment and the external equipment of the apparatus to each other, and a fixing board for attaching a connector on an end of the extension cable to an extension destination.

However, in Patent Literature 1, a method of attaching the connector on the end of the extension cable to the fixing board and a method of removing the connector from the fixing board are not described, and it is unknown whether there is a need to replace the extension cable together with the fixing board in order to replace the extension cable. When the cable is pulled in the lateral direction and the like when the extension cable is to be attached to the fixing board or in a state in which the extension cable is attached to the fixing board, there is a risk that an attaching part between the connector and the fixing board may be damaged. When the extension destination is indoors and the like and lighting is insufficient, it is difficult to check the position of the connector that is the extension destination.

### SUMMARY OF THE INVENTION

Thus, an object of the present disclosure is to provide a slot-in connector in which a connector on an end of an extension cable is easily attached and removed while a state in which an adapter (a replacement of a fixing board) for attachment to an extension destination is attached to a connection destination is maintained and the position of the connector is easily checked even when lighting at the extension destination is insufficient.
[1] A slot-in connector according to the present disclosure is a slot-in connector comprising a connector unit and an adapter. The connector unit includes a connector, an illuminating member, a light guiding member, a board, a case, and a cable. The connector is mounted on the board and includes an insertion hole into which a counterpart connector that is a connection counterpart of the connector is at least partially inserted. The insertion hole is open in a first direction. The first direction is an insertion and removal direction in which the connector and the counterpart connector are connected to and removed from each other. The board includes a light source part. The illuminating member is configured to illuminate the periphery of the insertion hole by light that has entered the illuminating member by the light guiding member that is configured to guide light emitted from the light source part. The case includes a main body part and a first latch part. The main body part includes an inner space that at least partially accommodates the connector, the illuminating member, the light guiding member, the board, and the cable in the inner space, and a first opening part that at least partially exposes the illuminating member to the outside of the case. The first latch part is provided on a surface of the main body part on one side in a second direction of the main body part and is elastically displaced to the other side in the second direction. The first latch part includes a first protruding part that protrudes to the one side in the second direction. The second direction is a direction substantially orthogonal to the first direction. The cable has one end part electrically connected to the board and another end part extracted to the outside of the case. The adapter includes an accommodation space that at least partially accommodates the connector unit in the accommodation space, a second opening part that at least partially exposes the illuminating member to the outside of the adapter, a first cut-out part that is open in the second direction and at least partially exposes the first latch part to the outside of the adapter, and a first engagement part on one side in the first direction of the first cut-out part. The first engagement part may be configured to be engaged with the first protruding part.
[2] The adapter may include a second cut-out part that is disposed opposite to the first cut-out part in the second direction. The second cut-out part may be open in the second direction.
[3] The case may include a second latch part that is provided on a surface of the main body part on the other side in the second direction. The second latch part may be configured to be elastically displaced to the one side in the second direction. The second latch part may be disposed opposite to the first latch part. The second latch part may include a second protruding part that protrudes to the other side in the second direction. The second cut-out part may at least partially expose the second latch part to the outside of the adapter. The adapter may include a second engagement part on the one side in the first direction of the second cut-out part. The second engagement part may be configured to be engaged with the second protruding part.
[4] The third direction may be a direction substantially orthogonal to the first direction and the second direction. A portion of the main body part that is accommodated in the accommodation space may be configured to have a length in the first direction that is longer than the length in the second direction and the length in the third direction.
[5] The illuminating member may have an illuminating base part.

The illuminating base part may include an illuminating through-hole that passes through the illuminating base part in the first direction and is fitted onto a periphery of the insertion hole of the connector, and an illuminating surface on the one side in the first direction. The illuminating surface may be disposed in the periphery of the insertion hole. The second opening part may be configured to expose the illuminating surface to the one side in the first direction.
[6] The illuminating member may include a flange part on the other side in the first direction of the illuminating member. The illuminating member may be restricted by the light guiding member from moving to the one side in the first direction. The illuminating member may be restricted by the board from moving to the other side in the first direction. The light guiding member may include a light guiding part through-hole that passes through the light guiding member in the first direction and that is fitted onto the illuminating member. The light guiding member may be restricted by the case from moving to the one side in the first direction. The light guiding member may be restricted by the flange part from moving to the other side in the first direction. The main body part may include a restriction wall that is erected toward the inner space side from at least one surface out of a surface in the second direction or a surface in a third direction that is a direction substantially orthogonal to the first direction and the second direction. The surface in the second direction may define the inner space. The surface in the third direction may define the inner space. The board may be restricted by the illuminating member from moving to the one side in the first direction. The connector may be restricted by the restriction wall from moving to the other side in the first direction.
[7] The light guiding member may include an entrance part which is disposed in the proximity of the light source part and into which light emitted from the light source part enters. The entrance part may be disposed in a position that at least partially overlaps with the light source part when seen in a direction perpendicular to a mounting surface of the board. The case may include a shielding wall erected toward the inner space side from a surface on the one side in the first direction. The surface on the one side in the first direction may define the inner space. The shielding wall may be configured to be disposed between the illuminating member and each of the light source part and the entrance part when seen in the direction perpendicular to the mounting surface of the board.

### EFFECTS OF THE INVENTION

With the feature configuration shown in [1], it is possible to easily attach and remove the connector on the end of the extension cable while maintaining a state in which an adapter (a replacement of the fixing board) for attachment to the extension destination is attached to the connection destination. Even when lighting at an extension destination is insufficient, the position of the connector is easily checked.

With the feature configuration shown in [2], it is possible to remove the connector unit from the adapter by pinching the first latch part of the case and the side opposite to the first latch part by one hand without pulling the cable.

With the feature configuration shown in [3], the connector unit does not fall off from the adapter even when engagement between one of the first latch part or the second latch part and the adapter is released by vibration or impact.

With the feature configuration shown in [4], it is possible to reduce the area of the connector unit when seen in the first direction.

With the feature configuration shown in [5], a situation in which the illuminating surface is excessively recessed to the accommodation space side and sufficient illumination cannot be performed does not occur. The illuminating member is fitted onto the connector, and hence the connector is capable of suppress damage due to twisted connection of the counterpart connector.

With the feature configuration shown in [6], it is possible to fix the illuminating member, the light guiding member, and the board in the inner space. In addition, even when the counterpart connector is inserted to the connector and is pushed in with excessive force, the movement of the connector can be blocked by the restriction wall. Therefore, the connector can be prevented from being pushed in and damaged.

With the feature configuration shown in [7], it is possible to prevent a situation in which the light emitted from the light source part directly enters the illuminating member and the illumination of the periphery of the insertion hole of the connector becomes non-uniform.

### BRIEF DESCRIPTION OF THE DRAWING

FIG. 1 is a perspective view 1 showing one example of a connector unit U and an adapter A according to an embodiment;

FIG. 2 is a perspective view 2 showing one example of the connector unit U and the adapter A according to the embodiment;

FIG. 3 is a perspective view 3 showing one example of the connector unit U and the adapter A according to the embodiment;

FIG. 4 is a perspective view 4 showing one example of the connector unit U and the adapter A according to the embodiment;

FIG. 5 is an exploded perspective view 1 showing one example of a connector unit according to the embodiment;

FIG. 6 is an exploded perspective view 2 showing one example of the connector unit according to the embodiment;

FIG. 7 is an exploded perspective view 3 showing one example of the connector unit according to the embodiment;

FIG. 8 is an exploded perspective view 4 showing one example of the connector unit according to the embodiment;

FIG. 9 is an exploded perspective view 5 showing one example of the connector unit according to the embodiment;

FIG. 10 is an exploded perspective view 6 showing one example of the connector unit according to the embodiment;

FIG. 11 is a sectional view 1 showing one example of the connector unit U according to the embodiment;

FIG. 12 is a sectional view 2 showing one example of the connector unit U according to the embodiment;

FIG. 13 is a sectional view 3 showing one example of the connector unit U according to the embodiment;

FIG. 14 is a perspective view 1 showing one example of a connector unit and an adapter according to a first modification;

FIG. 15 is a perspective view 2 showing one example of the connector unit and the adapter according to the first modification;

FIG. 16 is a perspective view 3 showing one example of the connector unit and the adapter according to the first modification;

FIG. 17 is a perspective view 4 showing one example of the connector unit and the adapter according to the first modification;

FIG. 18 is an exploded perspective view 1 showing one example of the connector unit according to the first modification;

FIG. 19 is an exploded perspective view 2 showing one example of the connector unit according to the first modification;

FIG. 20 is a perspective view 1 showing one example of a connector unit and an adapter according to a second modification;

FIG. 21 is a perspective view 2 showing one example of the connector unit and the adapter according to the second modification;

FIG. 22 is a perspective view 3 showing one example of the connector unit and the adapter according to the second modification;

FIG. 23 is a perspective view 4 showing one example of the connector unit and the adapter according to the second modification;

FIG. 24 is an exploded perspective view 1 showing one example of the connector unit according to the second modification; and

FIG. 25 is an exploded perspective view 2 showing one example of the connector unit according to the second modification.

### DETAILED DESCRIPTION

An embodiment of the present disclosure is described in detail below. Component parts having the same functions are denoted by the same identification numbers and overlapping description is omitted.

### Embodiment

An embodiment of a slot-in connector of the present disclosure is described below. Component elements of the slot-in connector of this embodiment can be combined with each other unless the component elements contradict each other. Materials, shapes, dimensions, numbers, arrangement, and the like configuring the component elements of the slot-in connectors according to this embodiment and modifications describe one example thereof and the design thereof can be freely modified as long as similar functions may be realized.

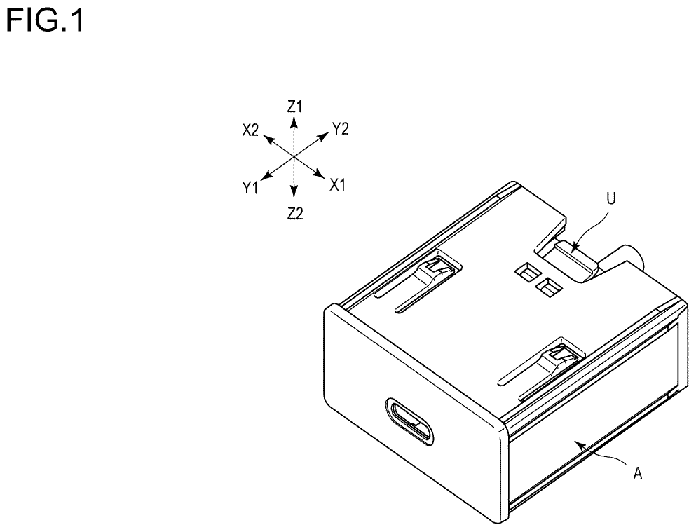

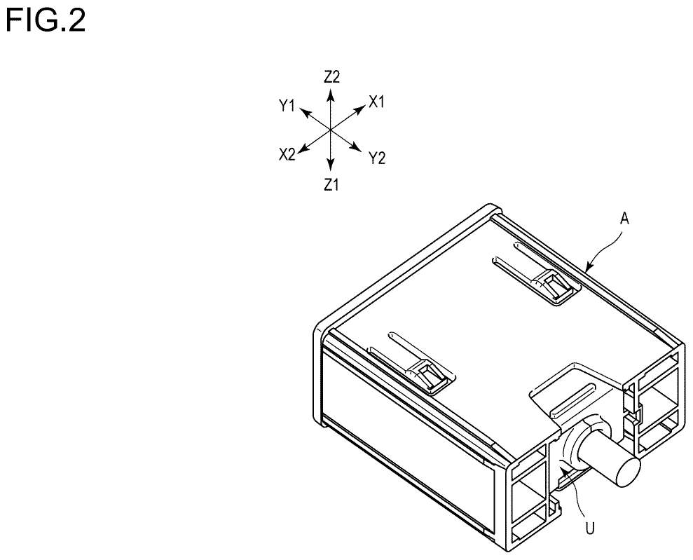

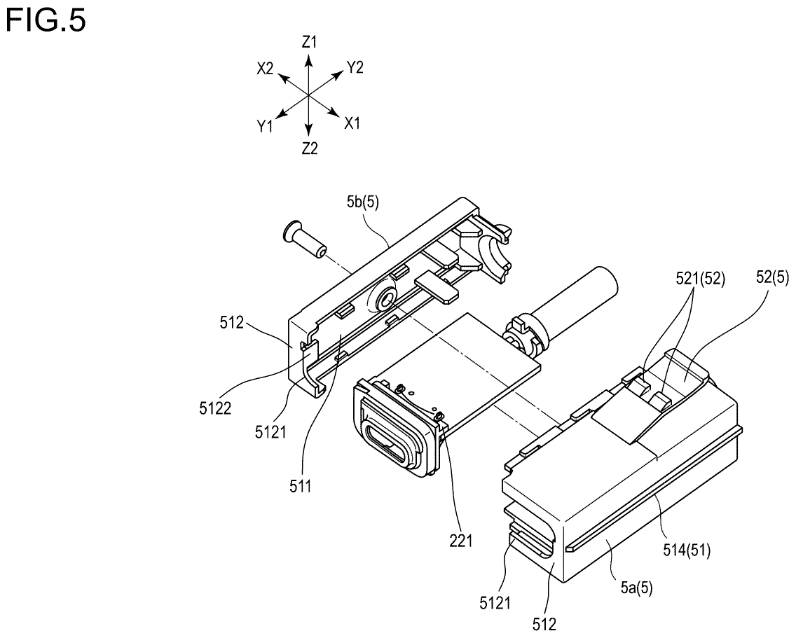

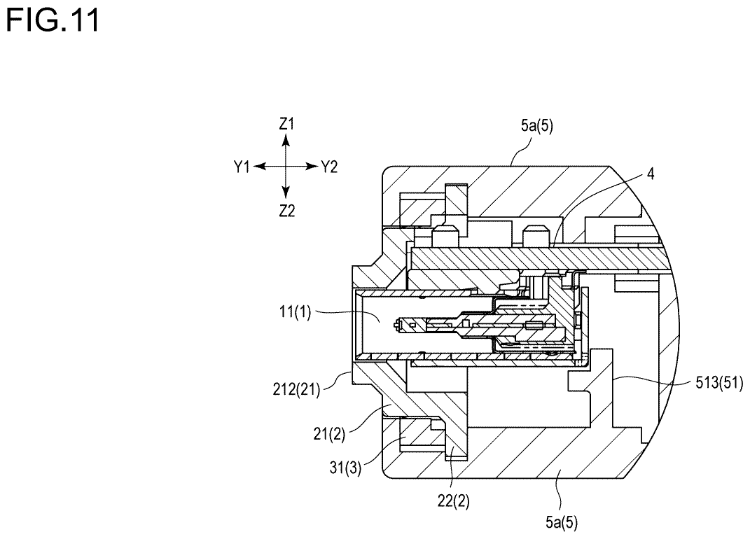

A slot-in connector according to the embodiment includes a connector unit U and an adapter A. FIG. 1 to FIG. 4 are perspective views showing one example of the connector unit U and the adapter A according to the embodiment. FIG. 5 to FIG. 10 are exploded perspective views showing one example of the connector unit U according to the embodiment. FIG. 11 to FIG. 13 are sectional views showing one example of the connector unit U according to the embodiment.

In each drawing, coordinate axes indicating a first direction, a second direction, and a third direction are shown. The first direction is a Y-direction, the second direction is a Z-direction, and the third direction is an X-direction. The second direction (Z-direction) is a direction substantially orthogonal to the first direction (Y-direction), and the third direction (X-direction) is a direction substantially orthogonal to the first direction (Y-direction) and the second direction (Z-direction).

Description is made below by considering one side in the first direction to be the Y1-side, the other side in the first direction to be the Y2-side, one side in the second direction to be the Z1-side, the other side in the second direction to be the Z2-side, one side in the third direction to be the X1-side, and the other side in the third direction to be the X2 side.

The first direction (Y-direction) is equivalent to an insertion and removal direction in which a connector and a counterpart connector described later are connected to and removed from each other and the Y1-side is the side on which the counterpart connector of the connector unit is inserted.

### [Connector Unit U and Adapter A]

As shown in FIG. 5 to FIG. 10, the connector unit U includes a connector 1, an illuminating member 2, a light guiding member 3, a board 4, a case 5, and a cable 6.

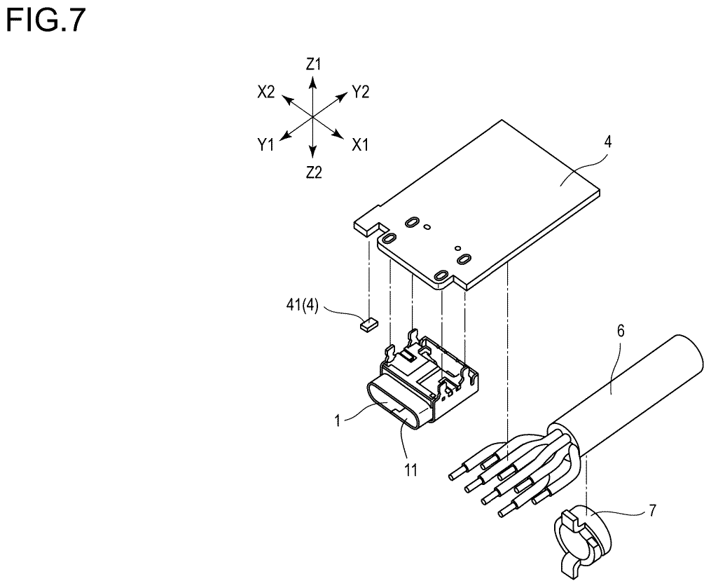

The connector 1 shown in FIG. 7 is mounted on the board 4 and has an insertion hole 11 that is open to the Y1-side. A counterpart connector (not shown) that is a connection counterpart of the connector 1 is at least partially inserted into the insertion hole 11.

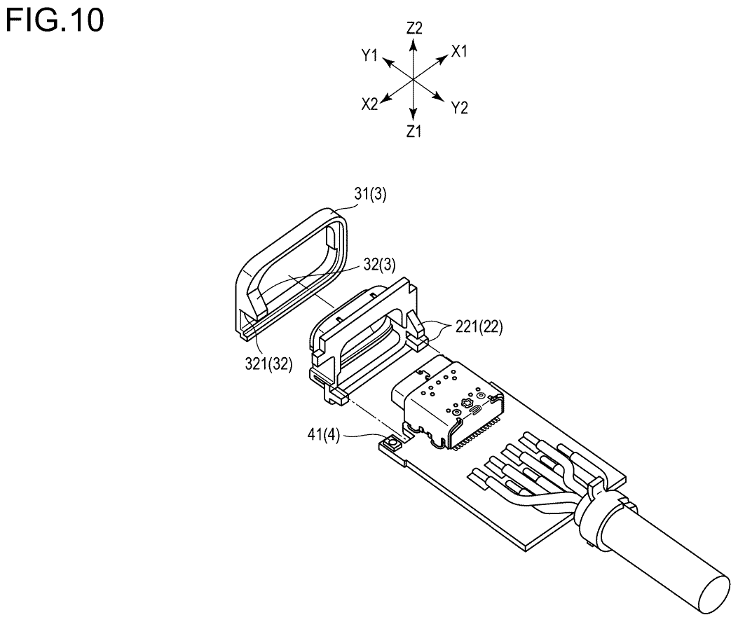

As shown in FIG. 10, the board 4 has a light source part 41. The illuminating member 2 illuminates the periphery of the insertion hole 11 by light that has entered the illuminating member 2 by the light guiding member 3 that guides light emitted from the light source part 41.

As shown in FIG. 5, the case 5 is configured by at least two members. For example, the case 5 may be formed by combining two parts, that is, a first case 5a and a second case 5b or may be configured by three or more members.

The case 5 has a main body part 51, and a first latch part 52 on a surface of the main body part 51 on the Z1-side thereof. The first latch part 52 is elastically displaced to the Z2-side.

As shown in FIG. 5, the main body part 51 has an inner space 511 that at least partially accommodates the connector 1, the illuminating member 2, the light guiding member 3, the board 4, and the cable 6 therein, and a first opening part 5121 that at least partially exposes the illuminating member 2 to the outside of the case 5.

The first latch part 52 is provided on the surface of the main body part 51 on the Z1-side thereof and is elastically displaced to the Z2-side. The first latch part 52 has first protruding parts 521 protruding to the Z1-side.

The case 5 may have a second latch part. The second latch part is provided on a surface of the main body part 51 on the Z2-side thereof, is elastically displaced to the Z1-side, and is disposed opposite to the first latch part 52. In this case, the second latch part has second protruding parts protruding to the Z2-side (neither the second latch part nor the second protruding part is illustrated, and the second latch part and the second protruding part can have shapes similar to those of the first latch part 52 and the first protruding part 521).

The first latch part 52 and the second latch part may have a leaf spring shape extending to Y2-side, may be formed on either the first case 5a or the second case 5b, and may be members separate from the case 5.

As shown in FIG. 7, the cable 6 has one end part electrically connected to the board 4 and another end part extracted to the outside of the case 5.

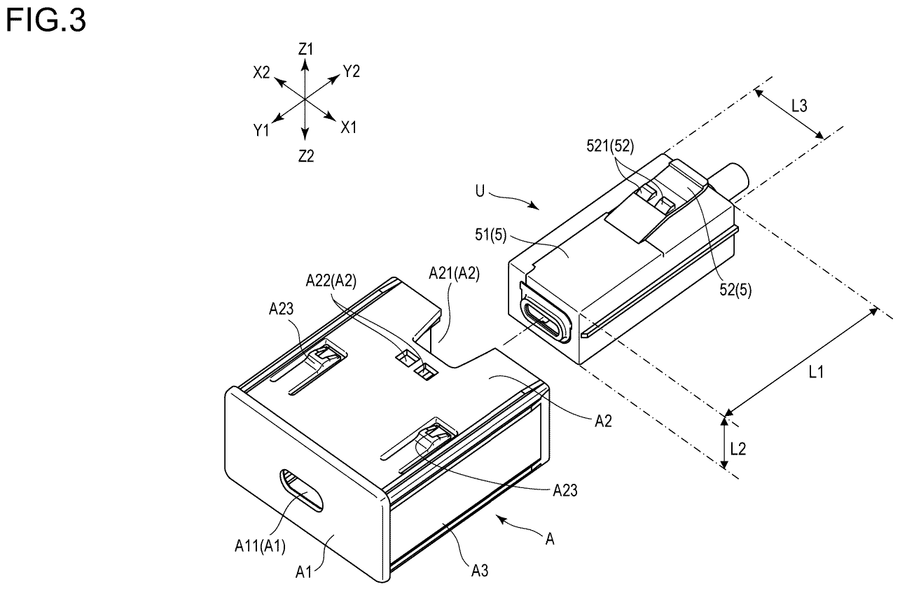

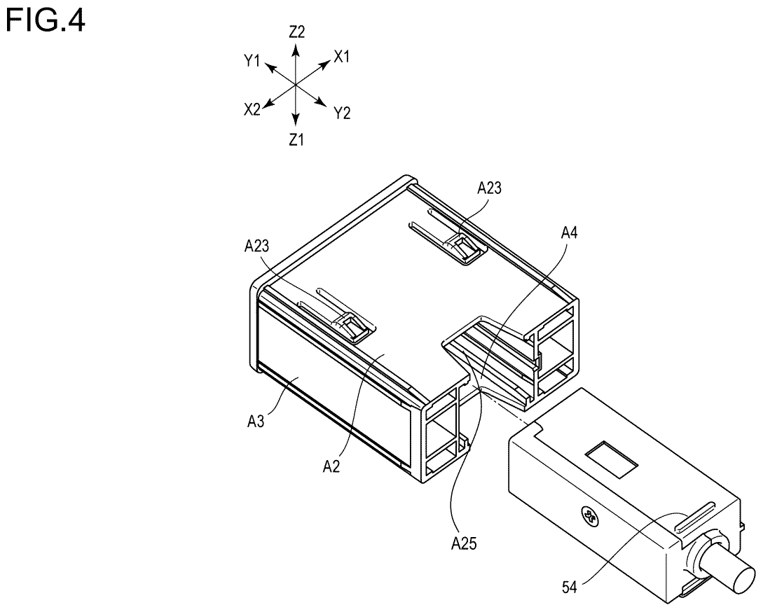

As shown in FIG. 3 and FIG. 4, the adapter A has a first wall A1 on the Y1-side, a pair of second walls A2 disposed to face each other on the Z1-side and the Z2-side, a pair of third walls A3 disposed to face each other on the X1-side and the X2 side, and an accommodation space A4. The accommodation space A4 is defined by the first wall A1, the second walls A2, and the third walls A3. The Y2-side of the accommodation space A4 is open. The accommodation space A4 at least partially accommodates the connector unit U therein.

The first wall A1 has a second opening part A11 that passes therethrough in the Y-direction and that at least partially exposes the illuminating member 2 to the outside of the adapter A. The number of the second opening parts A11 may be the same as that of the connectors 1 or may be more than that of the connectors 1.

The second wall A2 on the Z1-side out of the pair of second walls A2 has a first cut-out part A21 that is open to the Z1-side and that at least partially exposes the first latch part 52 to the outside of the adapter A, and first engagement parts A22 on the Y1-side of the first cut-out part A21. The first engagement parts A22 are engaged with the first protruding parts 521.

By the engagement between the first protruding parts 521 and the first engagement parts A22, the movement of the connector unit U to the Z2-side with respect to the adapter A is restricted. By releasing the engagement between the first protruding parts 521 and the first engagement parts A22, the connector unit U can be removed from the adapter A.

The second wall A2 on the Z2-side out of the pair of second walls A2 may include a second cut-out part A25 that is open to the Z2-side.

The adapter A may be formed by an insulating material, may be formed by a material having electrically conductivity, or may be formed by a material having an insulation property and have a metal-plated front surface.

When the second latch part is included on the main body part 51 on the Z2-side thereof, the second cut-out part A25 at least partially exposes the second latch part to the outside of the adapter A. On the Y1-side of the second cut-out part A25, the adapter A has second engagement parts that are engaged with the second protruding parts (the second engagement parts are not illustrated and can have shapes similar to those of the first engagement parts A22).

The first engagement parts A22 (second engagement parts) may have depressed shapes that are recessed outwards from a surface of the second wall A2 on the accommodation space A4 side thereof or may be holes passing through the second wall A2 in the second direction (Z-direction).

The number of the first engagement parts A22 (second engagement parts) may be the same as that of the first protruding parts 521 (second protruding parts) or may be one or plural.

When a plurality of the first engagement parts A22 (second engagement parts) and the first protruding parts 521 (second protruding parts) are provided, those parts may be formed to be spaced apart from each other in the third direction (X-direction).

The adapter A may have at least one incorporated part A23 in the second wall A2 or the third wall A3. The incorporated parts A23 may have the following structure. The incorporated parts A23 are elastically displaced, thereby enabling the adapter A to be moved to a predetermined position in an installation place when the adapter A is assembled to the installation place.

When the adapter A is moved to the predetermined position, the incorporated parts A23 return from the elastic displacement, thereby fixing the adapter A to the installation place.

The adapter A can be fixed to the installation place because the adapter A has the incorporated parts A23. Therefore, even when the counterpart connector is pulled in a Y1-direction, a situation in which the adapter A falls off from the installation place by being pulled by the counterpart connector can be prevented.

### [Connector 1]

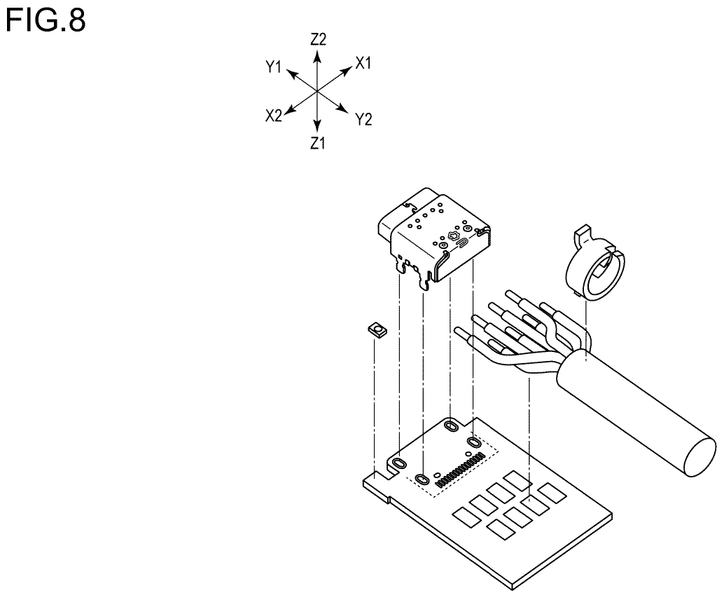

As shown in FIG. 7 and FIG. 8, the connector 1 is mounted on a front surface of the board 4. As a method of mounting the connector 1 onto the board 4, a well-known method can be used. For example, soldering can be used, or the connector 1 may be mounted on the board 4 by other methods.

The connector 1 may be a connector that complies with a Universal Serial Bus (USB) standard and can be a USB Type-C connector but may be a connector that complies with High-Definition Multimedia Interface (HDMI (R)) standard or other connectors.

### [Illuminating Member 2]

The illuminating member 2 may be formed by a transparent or translucent insulating material. Through treatment on a front surface of the illuminating member 2 or by a foreign matter mixed in the illuminating member 2, the illuminating member 2 may diffuse light that has entered the illuminating member 2 by the light guiding member 3.

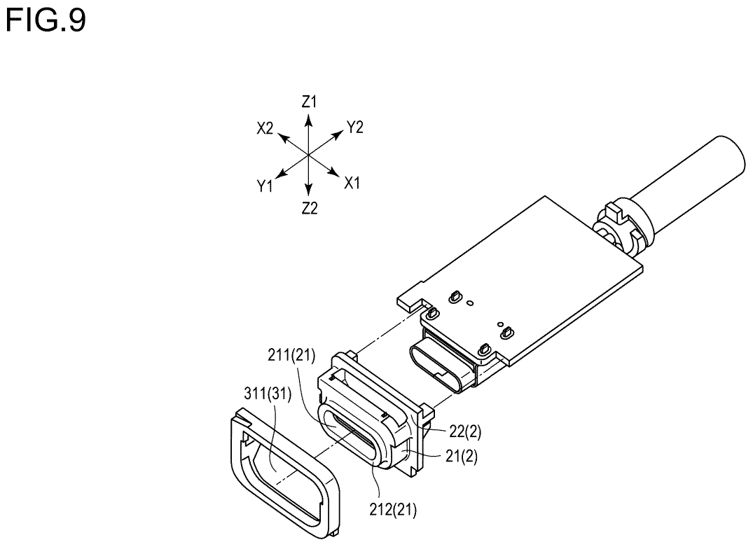

As shown in FIG. 9, the illuminating member 2 may have an illuminating base part 21. The illuminating base part 21 may have an illuminating through-hole 211 that passes therethrough in the first direction (Y-direction) and that is fitted onto the periphery of the insertion hole 11 of the connector 1. The illuminating base part 21 may have, on its Y1-side, an illuminating surface 212 to be disposed in the periphery of the insertion hole 11.

In this case, as shown in FIG. 1 and FIG. 3, the second opening part A11 in the first wall A1 of the adapter A is configured to expose the illuminating surface 212 to the Y1-side. At this time, the illuminating surface 212 may be disposed in a position that is flush with the first wall A1 or may be disposed to be slightly (from about 0.1 mm to about 0.5 mm) recessed to the Y2-side.

As shown in FIG. 9, on the Y2-side of the illuminating base part 21, the illuminating member 2 may have a flange part 22 provided to extend in a direction opposite to the illuminating through-hole 211.

As shown in FIG. 5 and FIG. 10, the flange part 22 may have board supporting parts 221 that support the board 4 by erecting from a surface on the Y2-side and coming into contact with each of a front surface and a rear surface of the board 4. A surface of the flange part 22 on the Y2-side thereof may abut against or be in the proximity of an end part of the board 4 on the Y1-side thereof.

### [Light Guiding Member 3]

The light guiding member 3 may be formed by a transparent insulating material or may have a light guiding base part 31 as shown in FIG. 9. As shown in FIG. 9, the light guiding base part 31 may have a light guiding through-hole 311 that passes through the light guiding base part 31 in the first direction (Y-direction) and that is fitted onto the illuminating base part 21.

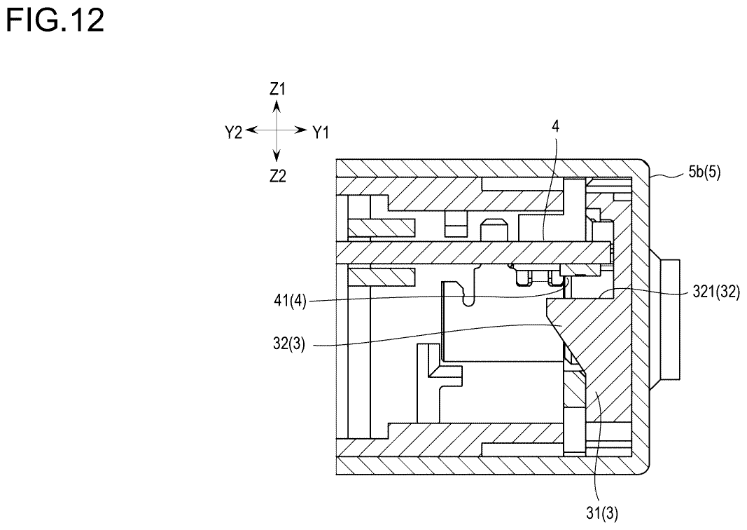

As shown in FIG. 10 and FIG. 12, the light guiding member 3 may have an entrance part 32 into which light emitted from the light source part 41 enters. The entrance part 32 may have a shape protruding to the Y2-side from a surface of the light guiding base part 31 on the Y2-side thereof or may be formed in a shape recessed to the Y1-side from the light guiding base part 31.

The entrance part 32 may be disposed in the proximity of the light source part 41 mounted on the board 4 and may have an entrance surface 321 facing the light source part 41. The entrance surface 321 may at least partially overlap with the light source part 41 when seen in a direction perpendicular to a mounting surface of the board 4.

The entrance part 32 may be possible to receive light output from the light source 41 mounted on the board 1 and cause the light to enter the illuminating base part 21 of the illuminating member 2 onto which an inner surface of the light guiding through-hole 311 in the light guiding base part 31 is fitted.

### [Board 4]

The board 4 may be disposed such that the layering direction becomes the same direction as the second direction (Z-direction) or may be disposed such that the layering direction becomes the same direction as the third direction (X-direction). As shown in FIG. 7 and FIG. 8, the light source part 41 may be mounted on the board 4 and the cable 6 may be electrically connected to the board 4. As a method of electrically connecting the cable 6 to the board 4, a well-known method can be used. For example, soldering may be performed, a connecting member may be used, or the cable 6 may be connected to the board 4 by other methods.

The board 4 may be a rigid board or a flexible board, may be a double sided board (two-layer board) formed by two layers, that is, a first surface and a second surface, or may be a multilayer board of three or more layers having an inner layer.

The connector 1 and the light source part 41 may be mounted on the same surface or may be mounted on different surfaces. The cable 6 may be electrically connected to a surface on which the connector 1 is mounted or may be electrically connected to a different surface.

### [Case 5]

In the case 5, each member may be formed by an insulating material, may be formed by a material having electrically conductivity, or may be formed by a material having an insulation property and have a metal-plated front surface.

As shown in FIG. 4, the case 5 may have a tab part 54 on the surface of the main body part 51 on the Z2-side thereof. The tab part 54 may be at least partially exposed to the Z2-side by the second cut-out part A25, may have a rib shape that protrudes to the Z2-side, extends in the third direction, and is erected, or may have a shape recessed to the Z1-side. The tab part 54 only needs to enable the connector unit U to be gripped such that a finger on the first latch part 52 and a finger on the tab part 54 do not slip when the main body part 51 is pinched with fingers.

As shown in FIG. 3, the main body part 51 may be configured such that a length L1 of a portion accommodated in the accommodation space A4 in the first direction (Y-direction) is longer than a length L2 thereof in the second direction (Z-direction) and a length L3 thereof in the third direction (X-direction), and may be entirely or substantially entirely accommodated in the accommodation space A4.

As shown in FIG. 5, the main body part 51 may have a case first wall 512 that closes the Y1-side of the inner space 511 or may have a restriction wall 513 that is erected toward the inner space 511 from at least one surface on the Z1-side, the Z2-side, the X1-side, or the X2 side defining the inner space 511 as shown in FIG. 11.

The restriction wall 513 may have a surface that is in the proximity of or abuts against the Y2-side of the connector 1 or have a surface that is in the proximity of or abuts against at least one surface of the connector 1 on the Z1-side, the Z2-side, the X1-side, or the X2 side thereof.

As shown in FIG. 5, the case first wall 512 may have a first opening part 5121 that passes therethrough in the first direction (Y-direction).

The number of the first opening parts 5121 may be the same as that of the connectors 1 or may be more than that of the connectors 1. The connector 1 and the illuminating member 2 may be at least partially disposed in the first opening part 5121. The first opening part 5121 may be formed to straddle over the first case 5a and the second case 5b.

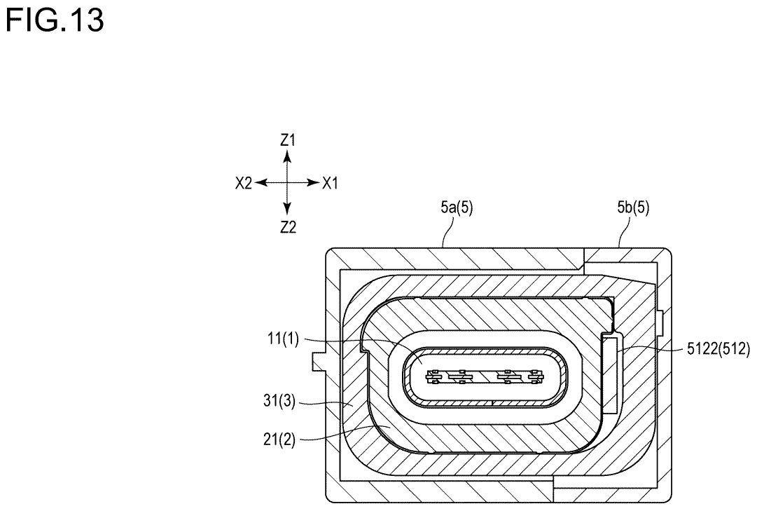

As shown in FIG. 5 and FIG. 13, a shielding wall 5122 that is erected toward the inner space 511 side from a surface of the case first wall 512 on the Y2-side thereof may be provided. The shielding wall 5122 may be configured to be disposed between the illuminating member 2 and each of the light source part 41 and the entrance part 32 when seen in the direction perpendicular to the mounting surface of the board 4 or may be formed by extending an end part of the first opening part 5121 to the Y2-side.

The main body part 51 may have a vertical rib part 514 on at least one surface on the Z1-side, the Z2-side, the X1-side, or the X2 side. The vertical rib part 514 is erected to protrude to the side opposite to the inner space 511 and extends in the first direction (Y-direction). The number of the vertical rib parts 514 may be one or plural, and the vertical rib part 514 may be used to prevent erroneous insertion of the connector unit U to the adapter A by changing the position and the number.

A well-known method can be used as a method of integrally assembling each member of the case 5 when the case 5 is configured by a plurality of members. For example, the members may be assembled in a so-called non-removably fixed state by a method of snap-fit and the like, the first case 5a and the second case 5b may be combined and fixed with a screw member and the like, and the members may be integrally assembled by other methods. The direction in which the first case 5a and the second case 5b are combined may be the second direction (Z-direction) or may be the third direction (X-direction). Alternatively, the first case 5a and the second case 5b may have a structure in which the first case 5a and the second case 5b are combined in the second direction (Z-direction) or the third direction (X-direction) and then are slid in the first direction (Y-direction), to thereby be disposed in the position of combination.

### [Cable 6]

The cable 6 may have at least one electric wire and a jacket formed by a material having an insulation property. The at least one electric wire may have a conductor formed by a material having electrical conductivity and a covering that covers the conductor, may have a plurality of electric wires capable of performing communication that complies with a USB standard and transmitting electricity, and may have at least one electric wire capable of supplying electricity to the light source part 41 of the board 4 besides the plurality of electric wires capable of performing communication that complies with a USB standard and transmitting electricity.

The cable 6 only needs to be configured such that the connector 1 is able to be connected to the counterpart connector and able to communicate with an external equipment (not shown, a mobile terminal, for example) or supply electricity to the light source part 41, and specifications and configurations of the at least one electric wire are not limited. The cable 6 may be a coaxial cable, for example.

The cable 6 may be electrically connected to the connector 1 via the board 4. A method of electrically connecting the cable 6 to the board 4 may be a method of exposing a conductor of an electric wire on one end side of the cable 6 and soldering or welding, for example, the conductor to a front surface electrode or a through-hole electrode formed on the board 4 or a method of connecting the cable 6 to the board 4 via a connecting part such as a terminal, and the electrical connection may be performed by other methods.

As shown in FIG. 7 and FIG. 8, on the cable 6, a fastening member 7 may be attached to a place near an end part on the side electrically connected to the board 4, and the cable 6 may be supported on the case 5 by the fastening member 7.

### [Assembling Method of Connector Unit U]

A method of assembling the connector unit U according to this embodiment is described. First, as shown in FIG. 7 and FIG. 8, the connector 1 and the light source part 41 are mounted on the board 4 by soldering and the like.

Conductors on distal end parts of the plurality of electric wires of the cable 6 are exposed and are connected to electrodes formed on the board 4 by soldering. The fastening member 7 is attached to a predetermined section of the cable 6 on the board side thereof by crimping. The attachment of the fastening member 7 may be performed before the connection to the board 4 that is performed by soldering.

Next, as shown in FIG. 9 and FIG. 10, the illuminating member 2 is moved to the Y2-side from the Y1-side, and the illuminating through-hole 211 is fitted onto the periphery of the insertion hole 11 of the connector 1.

At this time, as shown in FIG. 10, a surface of the illuminating base part 21 on the Y2-side thereof that is a surface between the board supporting parts 221 is moved until the surface abuts against an end part of the board 4 on the Y1-side thereof. Subsequently, as shown in FIG. 9, the light guiding member 3 is moved from the Y1-side to the Y2-side, and the light guiding through-hole 311 is fitted onto the illuminating base part 21.

At this time, the surface of the light guiding base part 31 on the Y2-side thereof is moved until the surface abuts against a surface of the flange part 22 of the illuminating member 2 on the Y1-side thereof.

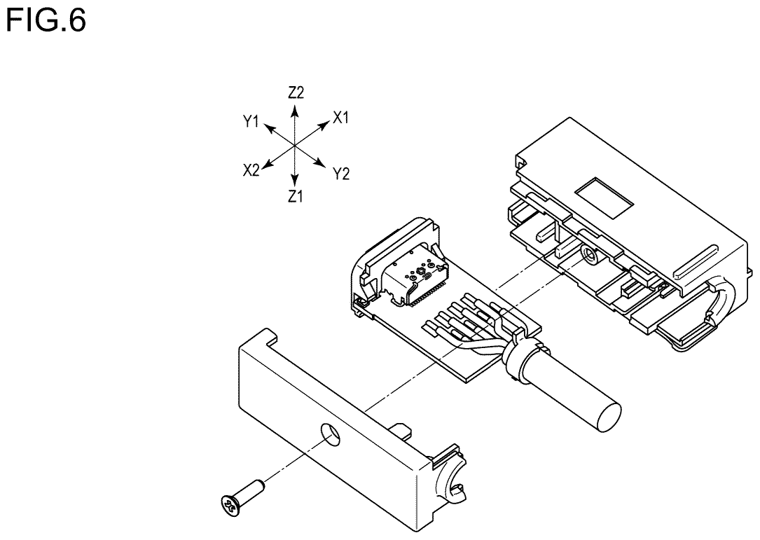

Next, as shown in FIG. 5 and FIG. 6, while maintaining a state in which the illuminating member 2 and the light guiding member 3 are supported with respect to the board 4, the board 4 is incorporated into the first case 5a, and the second case 5b is further combined with the first case 5a. As a result, the illuminating member 2 is restricted by the light guiding member 3 from moving to the Y1-side and is restricted by the board 4 from moving to the Y2-side, the light guiding member 3 is restricted by the case 5 from moving to the Y1-side and is restricted by the flange part 22 from moving to the Y2-side, the board 4 is restricted by the illuminating member 2 from moving to the Y1-side, and the connector 1 is restricted by the restriction wall 513 from moving to the Y2-side. As a result, the movement to the Y2-side is restricted, and the connector 1, the illuminating member 2, the light guiding member 3, and the board 4 are fixed in the inner space 511.

In the inner space 511 of the case 5, a wall structure other than the restriction wall 513 that supports the board 4 and the fastening member 7 is erected from a surface that defines the accommodation space 511, and hence the board 4 is fixed with respect to the first direction (Y-direction), the second direction (Z-direction), and the third direction (X-direction) in the inner space 511. As shown in FIG. 5 and FIG. 6, the assembling of the connector unit U is completed when the case 5b is fixed to the case 5a by a screw member. The board 4 may be incorporated in the order of incorporating the board 4 to the second case 5b and combining the first case 5a with the second case 5b.

### [Connecting Structure and Insertion and Removal Method of Connector Unit U and Adapter A]

A connecting structure of the connector unit U and the adapter A and an insertion and removal method of the connector unit U and the adapter A according to the embodiment are described. First, as shown in FIG. 3, when the connector unit U is moved from the Y2-side to the Y1-side to the adapter A in a state in which the adapter A is attached to the installation place and when the main body part 51 is inserted into the accommodation space A4, the first latch part 52 is elastically displaced to the Z2-side, and the first protruding parts 521 are accommodated in the accommodation space A4.

When the connector unit U is further moved to the Y1-side and an end part of the connector unit U on the Y1-side thereof abuts against a surface of the first wall A1 on the accommodation space A4 side thereof, the first protruding parts 521 are engaged with the first engagement parts A22, the first latch part 52 returns to the Z1-side, the connector unit U is prevented from moving to the Y2-side, and the connecting structure of the connector unit U and the adapter A is completed.

At this time, the first protruding parts 521 are exposed to the Z1-side by the first engagement parts A22 passing through the second wall A2 in the second direction (Z-direction), the Y2-side of the first latch part 52 is at least partially exposed to the Z1-side by the first cut-out part A21, and the tab part 54 is at least partially exposed to the Z2-side by the second cut-out part A25 as shown in FIG. 4.

When the second latch part is included instead of the tab part 54, the second latch part is elastically displaced to the Z1-side and returns to the Z2-side in a manner that is symmetrical to the first latch part 52. At the same time as the first protruding parts 521 of the first latch part 52 are engaged with the first engagement parts A22, the second protruding parts of the second latch part are also engaged with the second engagement parts on the Z2-side.

In a state in which the connecting structure is completed, the second protruding parts are exposed to the Z2-side by the second engagement parts that pass through the second wall A2 in the second direction (Z-direction), and the Y2-side of the second latch part is at least partially exposed to the Z2-side by the second cut-out part A25.

When the connector unit U is to be removed from the adapter A, the following is performed. When the tab part 54 is provided, while a state in which the adapter A is attached to the installation place is maintained, the first latch part 52 and the tab part 54 are pinched with fingers. Then, the first latch part 52 is elastically displaced to the Z2-side, and the engagement between the first protruding parts 521 and the first engagement parts A22 is released. When the connector unit U is moved to the Y2-side while the state of pinching the first latch part 52 and the tab part 54 with fingers is maintained, the connector unit U can be removed from the adapter A.

When the second latch part is included instead of the tab part 54, the following is performed. The first latch part 52 and the second latch part are pinched with fingers, the first latch part 52 is elastically displaced to the Z2-side, and the engagement between the first protruding parts 521 and the first engagement parts A22 is released. At the same time, the second latch part is elastically displaced to the Z1-side, and the engagement between the second protruding parts and the second engagement parts is released. When the connector unit U is moved to the Y2-side while the state of pinching the first latch part 52 and the second latch part with fingers is maintained, the connector unit U can be removed from the adapter A.

### [Technical Features and Effects]

The slot-in connector configured as above exhibits technical features and effects as below.

### (1) Effects of First Technical Feature [1]

The illuminating member 2 illuminates the periphery of the insertion hole 11 of the connector 1, and hence it is possible to easily perform the insertion of the counterpart connector even in places without sufficient lighting. With the connector unit U, it is possible to easily attach and remove the adapter A maintained in a state of being attached to an installation place that is a place with insufficient lighting simply by displacing the first latch part 52 with fingers without using a tool, a jig, and the like.

The first latch part 52 is at least partially exposed to the outside of the adapter A from the first cut-out part A21, and it is easy to grip the connector unit U at this portion and connect the connector unit U to the adapter A or remove the connector unit U from the adapter A. Therefore, from the viewpoint of providing a section for gripping the connector unit U, an end part of the case 5 on the Y2-side thereof does not necessarily need to protrude to the Y2-side from the accommodation space A4, and reduction in size and length of the case 5 in the first direction (Y-direction) can be realized.

### (2) Effects of Second Technical Feature [2]

It is possible to remove the connector unit U from the adapter A by pinching the first latch part 52 of the case 5 and the side opposite to the first latch part 52 by one hand without pulling the cable 6.

The first latch part 52 is at least partially disposed in the first cut-out part A21, the tab part 54 is at least partially exposed to the Z2-side by the second cut-out part A25, and the first latch part 52 and the tab part 54 are disposed opposite to each other in the second direction (Z-direction). Therefore, it is also possible to connect the connector unit U to the adapter A and remove the connector unit U from a connected state by pinching the first latch part 52 and the tab part 54 by fingers of one hand, and a risk in which, when the cable 6 is to be pulled while the first latch part 52 is operated with fingers at the time of removal, the electrical connection between the cable 6 and the board 4 is adversely affected can be suppressed.

### (3) Effects of Third Technical Feature [3]

The first latch part 52 and the second latch part are disposed opposite to each other in the second direction (Z-direction), and directions of elastic displacement for releasing the engagement with the adapter A are opposite directions. Therefore, even when the engagement of one latch part out of the first latch part 52 and the second latch part is released by vibration or impact, the other latch part continues to be engaged, and hence one latch part returns to the engaged state. As a result, the connector unit U can be prevented from accidentally falling off from the adapter A due to vibration or impact.

The first latch part 52 and the second latch part are disposed opposite to each other in the second direction (Z-direction), and hence operation with one hand is possible.

### (4) Effects of Fourth Technical Feature [4]

It is possible to reduce the area of the main body part 51 when seen in the first direction (Y-direction) when the length L1 of the portion accommodated in the accommodation space A4 in the first direction (Y-direction) is longer than the length L2 thereof in the second direction (Z-direction) and the length L3 thereof in the third direction (X-direction).

When the main body part 51 is entirely or substantially entirely accommodated in the accommodation space A4, a situation in which the main body part 51 is twisted with respect to the accommodation space A4 and the adapter A is damaged when the cable 6 is pulled in a direction inclined with respect to the first direction (Y-direction) can be suppressed.

### (5) Effects of Fifth Technical Feature [5]

A situation in which the illuminating surface 212 is excessively recessed to the accommodation space A4 side and the periphery of the insertion hole 11 is insufficiently illuminated can be suppressed. The illuminating member 2 is fitted onto the connector 1, the light guiding member 3 is fitted onto the illuminating member 2, and the illuminating surface 212 of the illuminating member 2 is disposed in the second opening part A11. Therefore, it is possible to suppress damage due to twisted connection of the counterpart connector. The illuminating surface 212 can be prevented from protruding to the Y1-side than the second opening part A11 and causing injury or damaging objects by interfering with people or objects.

At this time, when the illuminating surface 212 that is disposed in the same position in the first direction (Y-direction) as an end part of the connector 1 on the Y1-side thereof or in a position slightly (from about 0.1 mm to about 0.5 mm) on the Y1-side, a bearing force against twisted connection of the counterpart connector is improved more.

Even when the illuminating surface 212 is disposed in a position that is recessed by a small degree from a surface of the first wall A1 of the adapter A on the Y1-side thereof, that is, the end part of the connector 1 on the Y1-side thereof is disposed in a position that is recessed by a small degree from the surface of the first wall A1 on the Y1-side thereof, a gap is formed between a handle part of the counterpart connector and the surface of the first wall A1 on the Y1-side thereof in a state in which the counterpart connector is connected. Therefore, it is possible to visually recognize the counterpart connector by light leaking from the gap in an easy manner when the counterpart connector is to be removed.

### (6) Effects of Sixth Technical Feature [6]

The illuminating member 2, the light guiding member 3, and the board 4 can be fixed in the inner space 511. At the same time, even when the counterpart connector is inserted to the connector 1 and is pushed in with excessive force, a situation in which the connector 1 is damaged by being pushed or the electrical connection between the connector 1 and the board 4 is adversely affected can be suppressed by the restriction wall 513. For example, a situation in which solder separation occurs in a portion in which the connector 1 and the board 4 are soldered and the portion becomes an open circuit can be prevented.

Screw fixing and the like do not necessarily need to be performed in order to fix the board 4 to the inner space 511. This contributes to simplification and reduction in weight of the connector unit U.

### (7) Effects of Seventh Technical Feature [7]

The light emitted from the light source part 41 can be prevented from directly entering the illuminating member 2 without passing through the light guiding member 3 by light leakage, the distribution of the light in the illuminating base part 21 of the illuminating member 2 can be maintained to be uniform, and the illumination of the periphery of the insertion hole 11 of the connector 1 by the illuminating surface 212 can be maintained to be uniform.

When a chip LED is used as the light source part 41, a reflector type having a light leakage preventing effect does not necessarily need to be selected, and hence an inexpensive chip LED can be used as the light source part 41.

### First Modification (Slot×2, Z-Direction Lateral Array)

In the slot-in connector of the present disclosure, two connectors 1 may be disposed such that the connectors 1 are spaced apart from each other in the second direction (Z-direction) and the longitudinal direction of the slot faces the Z-direction. A structure of a slot-in connector according to a first modification in which two connectors 1 are spaced apart from each other in the second direction (Z-direction) and the longitudinal direction of a slot faces the Z-direction is described.

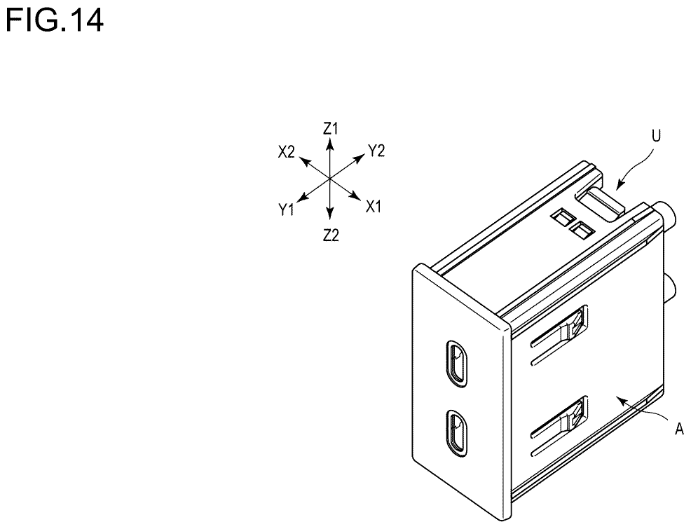

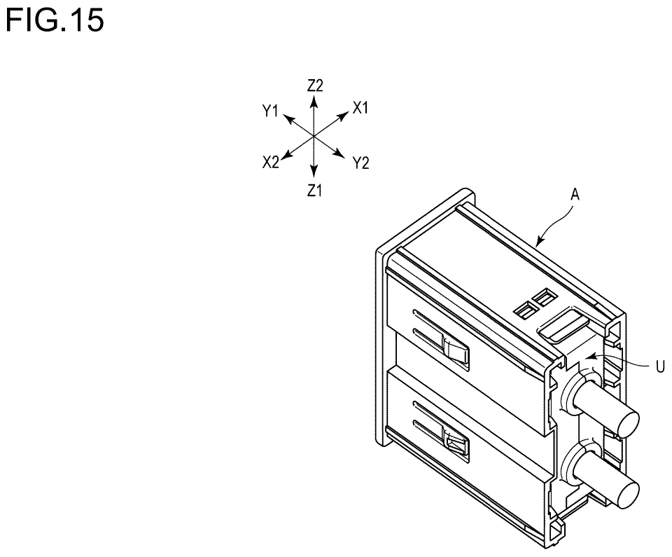

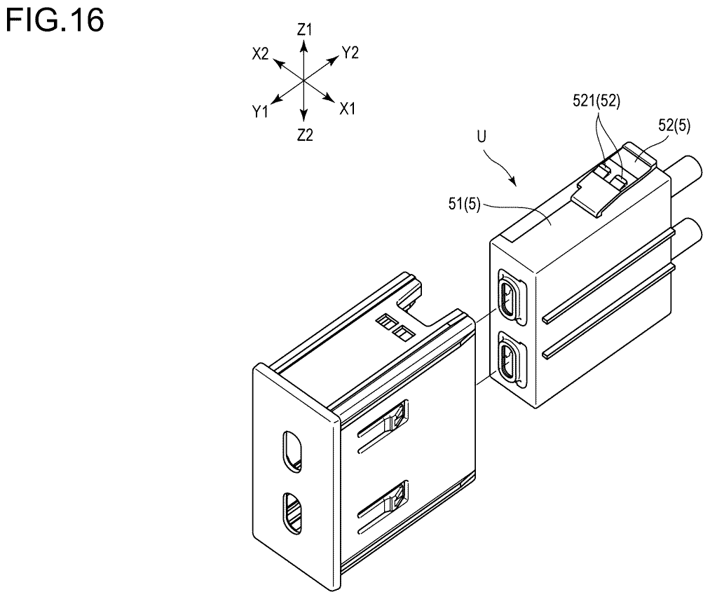

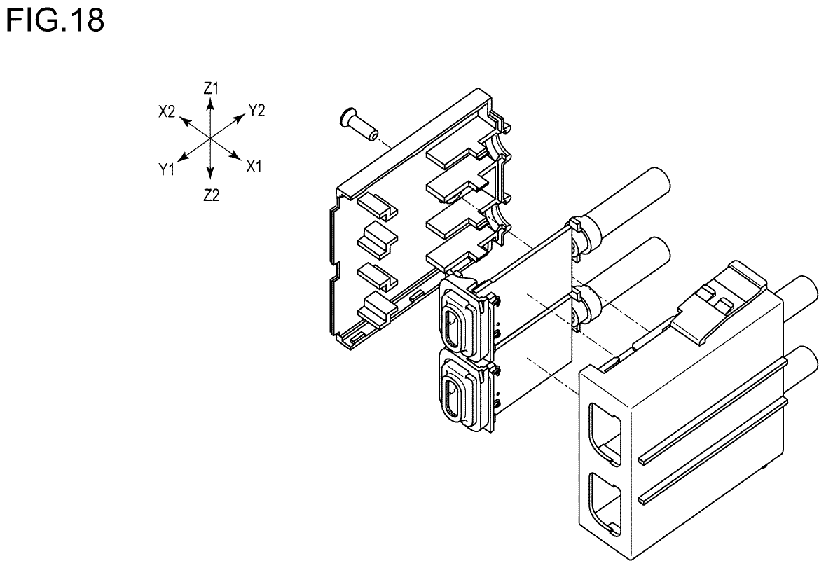

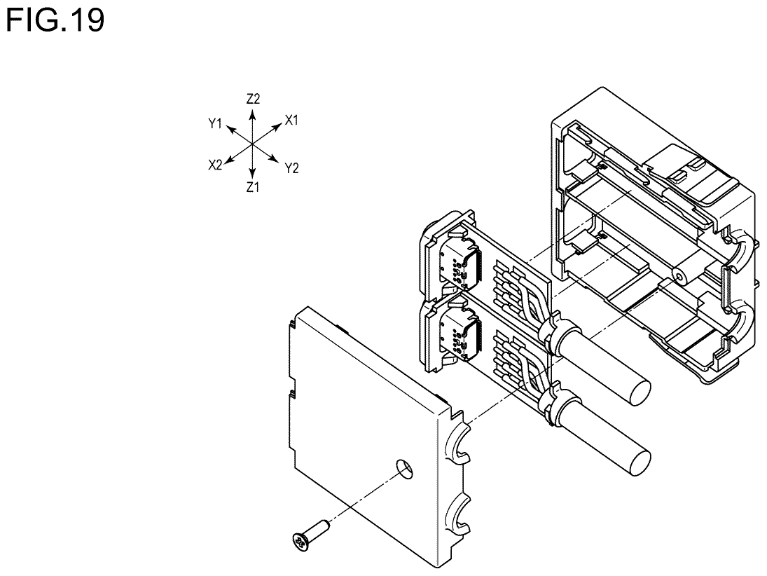

FIG. 14 to FIG. 17 are perspective views showing one example of a connector unit and an adapter according to the first modification. FIG. 18 and FIG. 19 are exploded perspective views showing one example of the connector unit according to the first modification.

As shown in FIG. 18 and FIG. 19, in the board 4, the layering direction may be parallel to the third direction (X-direction). The illuminating members 2 may be disposed such that the illuminating through-holes 211 are fitted onto the peripheries of the insertion holes 11 of the connectors 1.

At this time, the illuminating members 2 may be separate bodies that are the same in number as the connectors 1. Alternatively, the illuminating members 2 may be integrally formed and have the illuminating through-holes 211 that are same in number as the connectors, and the illuminating through-holes 211 may be fitted onto the peripheries of the insertion holes 11 of the connectors 1, respectively.

The light guiding members 3 may be separate bodies that are the same in number as the connectors 1. Alternatively, the light guiding members 3 may be formed as one and have the light guiding through-holes 311 that are the same in number as the connectors 1, and the light guiding through-holes 311 may be fitted onto the illuminating members 2 fitted onto the connectors 1. The same number of the entrance parts 32 as the number of the light source parts 41 may be included.

The boards 4 may be separate bodies that are the same in number as the connectors 1 and one connector 1 may be mounted on one board 4 or a plurality of the connectors 1 may be mounted on one board 4.

The cables 6 may be the same in number as the connectors 1 and may be electrically connected to the boards 4, respectively, one cable 6 may be electrically connected to one board 4, or the cables 6 that are the same in number as the connectors 1 may be electrically connected to one board 4.

When one connector 1 is mounted on one board 4 and one cable 6 electrically connected to one board 4, this configuration can be handled as a board assembly, and it becomes possible to use this configuration as a common board assembly obtained by parts that are in common with the connector unit U of the embodiment.

When one connector 1 is mounted on one board 4, one cable 6 is electrically connected to one board 4, one illuminating member 2 is fitted onto the connector 1, and one light guiding member 3 is fitted onto one illuminating member 2, this configuration can be handled as a board assembly by also including the illuminating member 2 and the light guiding member 3, and it becomes possible to use this configuration as a common board assembly obtained by parts that are in common with the connector unit U of the embodiment.

When the layering direction of the board 4 is parallel to the third direction (X-direction), it is possible to shorten the length of the connector unit in the third direction (X-direction).

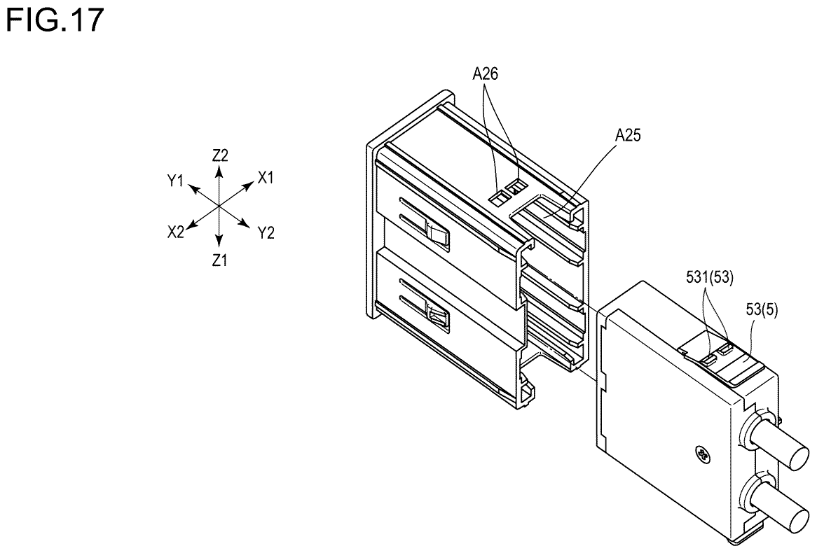

The second latch part, the second protruding parts, and the second engagement parts of which illustration is omitted in the embodiment described above are illustrated as a second latch part 53, second protruding parts 531, and second engagement parts A26 in FIG. 17.

### Second Modification (Slot×2, Z-Direction Vertical Array)

In the slot-in connector of the present disclosure, two connectors 1 may be disposed such that the connectors 1 are spaced apart from each other in the second direction (Z-direction) and the longitudinal direction of the slot faces the X-direction. A structure of a slot-in connector according to a second modification in which two connectors 1 are spaced apart from each other in the second direction (Z-direction) and the longitudinal direction of a slot faces the X-direction is described.

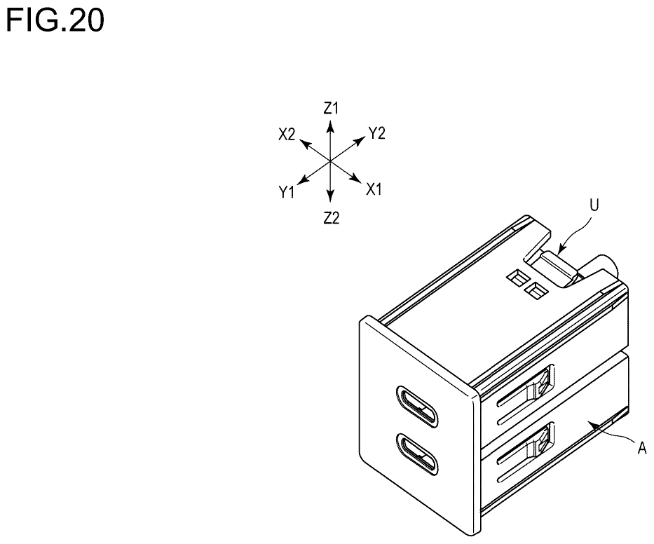

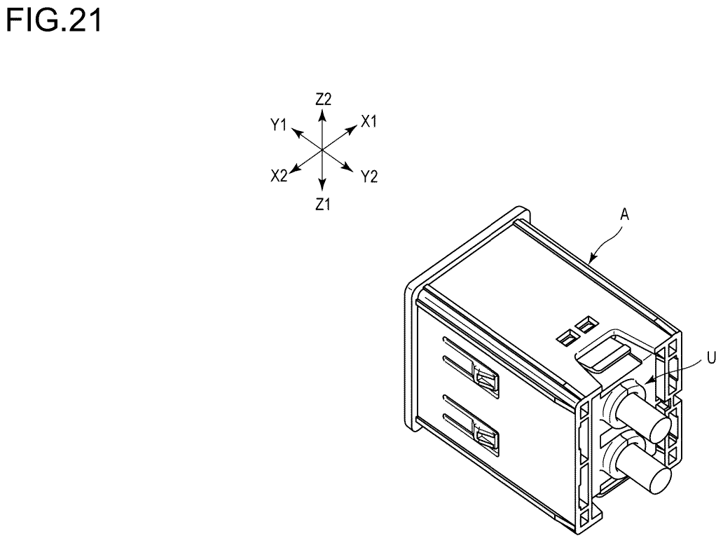

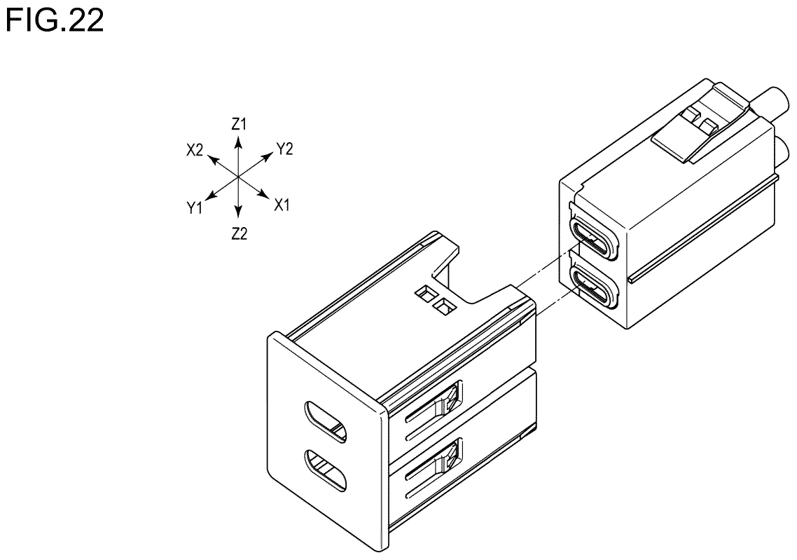

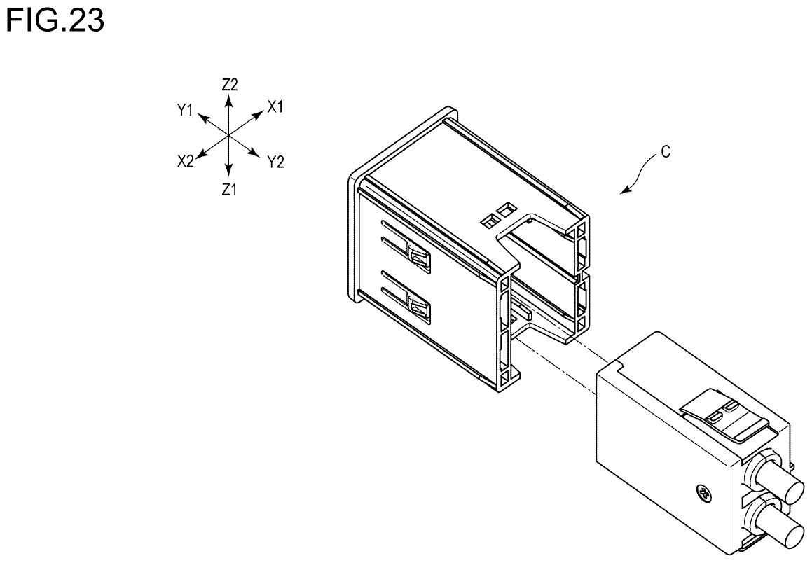

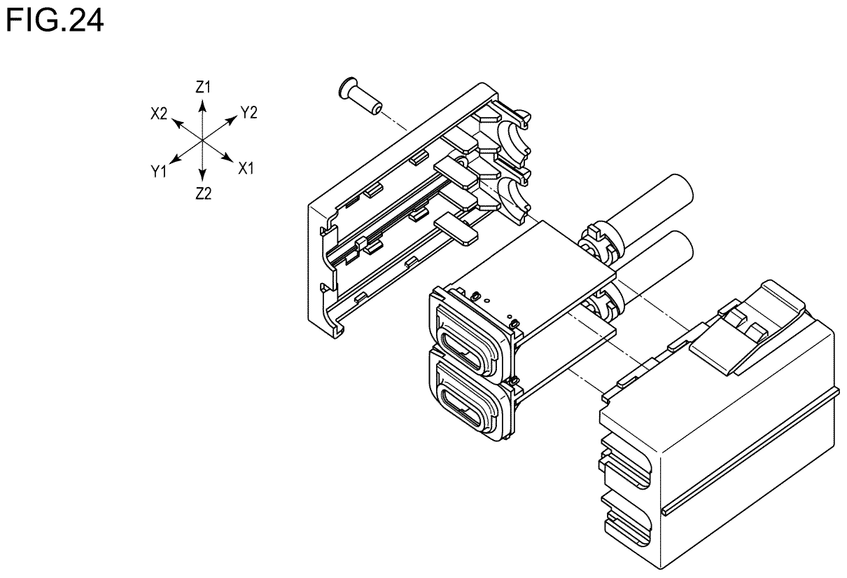

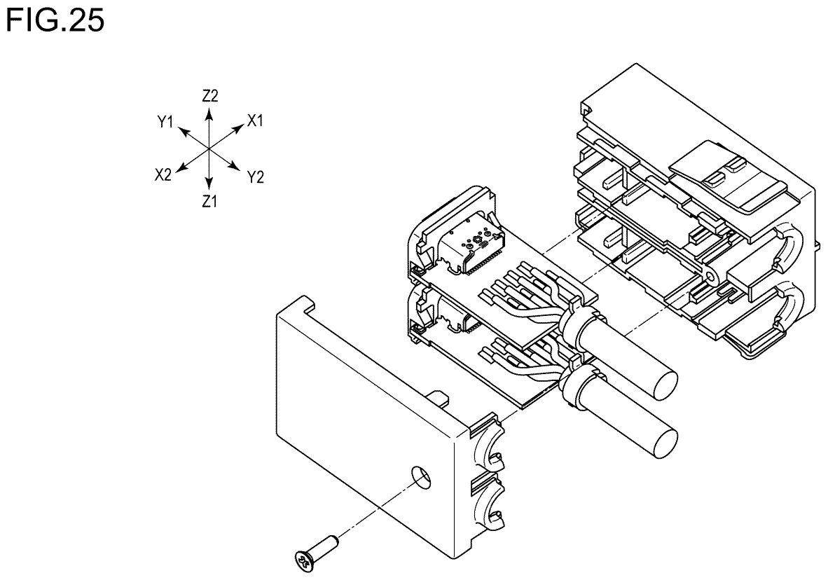

FIG. 20 to FIG. 23 are perspective views showing one example of a connector unit and an adapter according to the second modification. FIG. 24 and FIG. 25 are exploded perspective views showing one example of the connector unit according to the second modification.

As shown in FIG. 24 and FIG. 25, in the board 4, the layering direction may be parallel to the second direction (Z-direction). The illuminating members 2 may be disposed such that the illuminating through-holes 211 are fitted onto the peripheries of the insertion holes 11 of the connectors 1.

At this time, the illuminating members 2 may be separate bodies that are the same in number as the connectors 1. Alternatively, the illuminating members 2 may be integrally formed and have the illuminating through-holes 211 that are same in number as the connectors 1, and the illuminating through-holes 211 may be fitted onto the peripheries of the insertion holes 11 of the connectors 1, respectively.

The light guiding members 3 may be separate bodies that are the same in number as the connectors 1. Alternatively, the light guiding members 3 may be formed as one and have the light guiding through-holes 311 that are the same in number as the connectors 1, and the light guiding through-holes 311 may be fitted onto the illuminating members 2 fitted onto the connectors 1. The same number of the entrance parts 32 as the number of the light source parts 41 may be included.

The boards 4 are separate bodies that are the same in number as the connectors 1, and one connector 1 is mounted on one board 4. The cables 6 that are the same in number as the connectors 1 are electrically connected to the boards 4, respectively.

When one connector 1 is mounted on one board 4 and one cable 6 electrically connected to one board 4, this configuration can be handled as a board assembly, and it becomes possible to use this configuration as a common board assembly obtained by parts that are in common with the connector unit U of the embodiment.

When one connector 1 is mounted on one board 4, one cable 6 is electrically connected to one board 4, one illuminating member 2 is fitted onto the connector 1, and one light guiding member 3 is fitted onto one illuminating member 2, this configuration can be handled as a board assembly by also including the illuminating member 2 and the light guiding member 3, and it becomes possible to use this configuration as a common board assembly obtained by parts that are in common with the connector unit U of the embodiment.

The layering direction of the board 4 is parallel to the second direction (Z-direction), and hence it is possible to shorten the length of the connector unit in the second direction (Z-direction).

### Third Modification (Not Shown)

The adapter of the slot-in connector of the present disclosure may be integrally formed with the installation place. For example, when the installation place of the adapter is inside a vehicle, the adapter may be integrally formed with the inner side of a door, an instrument panel, a center console, and the like of the vehicle.

### Industrial Applicability

The slot-in connector of the present disclosure can be used as an extension port that extends an I/O port of an electronic device, for example.

What is claimed is:

1. A slot-in connector comprising a connector unit and an adapter, wherein:
the connector unit includes:
a connector;
an illuminating member;
a light guiding member;
a board;
a case; and
a cable;
the connector is mounted on the board and includes an insertion hole into which a counterpart connector that is a connection counterpart of the connector is at least partially inserted, the insertion hole being open in a first direction;
the first direction is an insertion and removal direction in which the connector and the counterpart connector are connected to and removed from each other;
the board includes a light source part;
the illuminating member is configured to illuminate a periphery of the insertion hole by light that has entered the illuminating member by the light guiding member that is configured to guide light emitted from the light source part;
the case includes:
a main body part; and
a first latch part;
the main body part includes:
an inner space that at least partially accommodates the connector, the illuminating member, the light guiding member, the board, and the cable in the inner space; and
a first opening part that at least partially exposes the illuminating member to an outside of the case;
the first latch part is provided on a surface of the main body part on one side in a second direction of the main body part and is configured to be elastically displaced to another side in the second direction;
the first latch part includes a first protruding part that protrudes to the one side in the second direction;
the second direction is a direction substantially orthogonal to the first direction;
the cable has one end part electrically connected to the board and another end part extracted to the outside of the case; and
the adapter includes:
an accommodation space that at least partially accommodates the connector unit in the accommodation space;
a second opening part that at least partially exposes the illuminating member to an outside of the adapter;
a first cut-out part that is open in the second direction and at least partially exposes the first latch part to the outside of the adapter; and
a first engagement part on one side in the first direction of the first cut-out part, the first engagement part being configured to be engaged with the first protruding part.

2. The slot-in connector according to claim 1, wherein the adapter includes a second cut-out part that is disposed opposite to the first cut-out part in the second direction, the second cut-out part being open in the second direction.

3. The slot-in connector according to claim 2, wherein:
the case includes a second latch part that is provided on a surface of the main body part on the other side in the second direction, the second latch part being configured to be elastically displaced to the one side in the second direction, the second latch part being disposed opposite to the first latch part;
the second latch part includes a second protruding part that protrudes to the other side in the second direction;
the second cut-out part at least partially exposes the second latch part to the outside of the adapter; and
the adapter includes a second engagement part on the one side in the first direction of the second cut-out part, the second engagement part being configured to be engaged with the second protruding part.

4. The slot-in connector according to claim 1, wherein:
the third direction is a direction substantially orthogonal to the first direction and the second direction; and
a portion of the main body part that is accommodated in the accommodation space has a length in the first direction that is longer than a length in the second direction and a length in the third direction.

5. The slot-in connector according to claim 1, wherein:
the illuminating member has an illuminating base part;
the illuminating base part includes:
an illuminating through-hole that passes through the illuminating base part in the first direction and that is fitted onto a periphery of the insertion hole of the connector; and
an illuminating surface on the one side in the first direction, the illuminating surface being disposed in the periphery of the insertion hole; and
the second opening part exposes the illuminating surface to the one side in the first direction.

6. The slot-in connector according to claim 1, wherein:
the illuminating member includes a flange part on another side in the first direction of the illuminating member, the illuminating member being restricted by the light guiding member from moving to the one side in the first direction, the illuminating member being restricted by the board from moving to the other side in the first direction;
the light guiding member includes a light guiding part through-hole that passes through the light guiding member in the first direction, the light guiding member being fitted onto the illuminating member, the light guiding member being restricted by the case from moving to the one side in the first direction, the light guiding member being restricted by the flange part from moving to the other side in the first direction;
the main body part includes a restriction wall that is erected toward the inner space side from at least one surface out of a surface in the second direction or a surface in a third direction that is a direction substantially orthogonal to the first direction and the second direction, the surface in the second direction defining the inner space, the surface in the third direction defining the inner space;
the board is restricted by the illuminating member from moving to the one side in the first direction; and
the connector is restricted by the restriction wall from moving to the other side in the first direction.

7. The slot-in connector according to claim 1, wherein:
the light guiding member includes an entrance part which is disposed in proximity of the light source part and into which light emitted from the light source part enters;
the entrance part is disposed in a position that at least partially overlaps with the light source part when seen in a direction perpendicular to a mounting surface of the board;
the case includes a shielding wall erected toward the inner space side from a surface on the one side in the first direction, the surface on the one side in the first direction defining the inner space; and
the shielding wall is disposed between the illuminating member and each of the light source part and the entrance part when seen in the direction perpendicular to the mounting surface of the board.
